(19) United States
(12) Patent Application Publication
(10) Pub. No.: US 2020/0014536 A1
(43) Pub. Date: Jan. 9, 2020

(54) CRYPTOGRAPHIC KEY SYSTEM AND METHOD

(71) Applicant: Strike Derivatives, Inc., New York, NY (US)

(72) Inventors: CHARLES R. WALDEN, Austin, TX (US); Roman Brodetskiy, Hamburg (DE); Adam August, Brooklyn, NY (US)

(21) Appl. No.: 16/504,945

(22) Filed: Jul. 8, 2019

Related U.S. Application Data
(60) Provisional application No. 62/694,566, filed on Jul. 6, 2018.

(51) Int. Cl. H04L 9/32; G06Q 20/38; G06Q 20/40

(52) U.S. Cl. CPC H04L 9/3213; G06Q 20/405; G06Q 20/3829; H04L 9/3247

(57) ABSTRACT

A computer-implemented method, computer program product and computing system for assigning to a utility token a first key configured to effectuate a first functionality; and assigning to the utility token at least a second key configured to effectuate at least a second functionality.

### RELATED APPLICATION(S)

This application claims the benefit of U.S. Provisional Application No. 62/694,566, filed on 6 Jul. 2018, the entire contents of which are incorporated herein by reference.

### TECHNICAL FIELD

This disclosure relates to cryptographic keys and, more particularly, to private-public cryptographic key pairs.

### BACKGROUND

Most modern cryptocurrency transactions are sent from user to user using a cryptocurrency wallet, wherein a cryptocurrency wallet is a secure way to store, send and receive cryptocurrency. The cryptocurrency wallet is secured using a public key that identifies the address of the cryptocurrency wallet, and a private key that is only available and known to the owner of the cryptocurrency wallet. Currently, most cryptocurrency wallets use only one private key for all purposes (including to sign and authorize transactions).

There also exists what are known as multi-signature cryptocurrency wallets, wherein these cryptocurrency wallets have multiple private keys (or a private key that has been encrypted and split into several pieces), some combination of which are necessary to enable the wallet (similar to co-signers on a bank account). Regardless of the number of private keys, all of the private keys serve the same function and have the authority to perform all the same actions.

### SUMMARY OF DISCLOSURE

In one implementation, a computer-implemented method is executed a computing device and includes: assigning to a utility token a first key configured to effectuate a first functionality; and assigning to the utility token at least a second key configured to effectuate at least a second functionality.

One or more of the following features may be included. The utility token may be based upon a smart contract. The first functionality may include enabling the unrestricted transfer of ownership of the utility token from a first party to a second party. The at least a second functionality may include: enabling the staking of the utility token without requiring the transfer of ownership of the utility token. Enabling the staking of the utility token without requiring the transfer of ownership of the utility token may include: allowing an owner of the utility token to use the utility token as collateral for a vote cast. Enabling the staking of the utility token without requiring the transfer of ownership of the utility token may include: enabling penalization of the owner of the utility token in response to bad behavior concerning the vote cast. Enabling the staking of the utility token without requiring the transfer of ownership of the utility token may include: enabling rewarding of the owner of the utility token in response to good behavior concerning the vote cast. The at least a second functionality may include: enabling the restricted transfer of ownership of the utility token from the first party to one or more of a group of approved parties. The at least a second functionality may include: enabling the escrow transfer of ownership of the utility token from a first party to a holding party.

In another implementation, a computing system includes a processor and memory is configured to perform operations including assigning to a utility token a first key configured to effectuate a first functionality; and assigning to the utility token at least a second key configured to effectuate at least a second functionality.

One or more of the following features may be included. The utility token may be based upon a smart contract. The first functionality may include enabling the unrestricted transfer of ownership of the utility token from a first party to a second party. The at least a second functionality may include: enabling the staking of the utility token without requiring the transfer of ownership of the utility token. Enabling the staking of the utility token without requiring the transfer of ownership of the utility token may include: allowing an owner of the utility token to use the utility token as collateral for a vote cast. Enabling the staking of the utility token without requiring the transfer of ownership of the utility token may include: enabling penalization of the owner of the utility token in response to bad behavior concerning the vote cast. Enabling the staking of the utility token without requiring the transfer of ownership of the utility token may include: enabling rewarding of the owner of the utility token in response to good behavior concerning the vote cast. The at least a second functionality may include: enabling the restricted transfer of ownership of the utility token from the first party to one or more of a group of approved parties. The at least a second functionality may include: enabling the escrow transfer of ownership of the utility token from a first party to a holding party.

In another implementation, a computer program product resides on a computer readable medium and has a plurality of instructions stored on it. When executed by a processor, the instructions cause the processor to perform operations including assigning to a utility token a first key configured to effectuate a first functionality; and assigning to the utility token at least a second key configured to effectuate at least a second functionality.

One or more of the following features may be included. The utility token may be based upon a smart contract. The first functionality may include enabling the unrestricted transfer of ownership of the utility token from a first party to a second party. The at least a second functionality may include: enabling the staking of the utility token without requiring the transfer of ownership of the utility token. Enabling the staking of the utility token without requiring the transfer of ownership of the utility token may include: allowing an owner of the utility token to use the utility token as collateral for a vote cast. Enabling the staking of the utility token without requiring the transfer of ownership of the utility token may include: enabling penalization of the owner of the utility token in response to bad behavior concerning the vote cast. Enabling the staking of the utility token without requiring the transfer of ownership of the utility token may include: enabling rewarding of the owner of the utility token in response to good behavior concerning the vote cast. The at least a second functionality may include: enabling the restricted transfer of ownership of the utility token from the first party to one or more of a group of approved parties. The at least a second functionality may include: enabling the escrow transfer of ownership of the utility token from a first party to a holding party.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a cryptographic key process according to an embodiment of the present disclosure;

FIG. 2 is a diagrammatic view of utility tokens, cryptographic keys and interested parties; and

FIG. 3 is a flowchart of an implementation of the cryptographic key process of FIG. 1 according to an embodiment of the present disclosure.

Like reference symbols in the various drawings indicate like elements.

### DETAILED DESCRIPTION OF THE PREFERRED EMBODIMENTS

System Overview

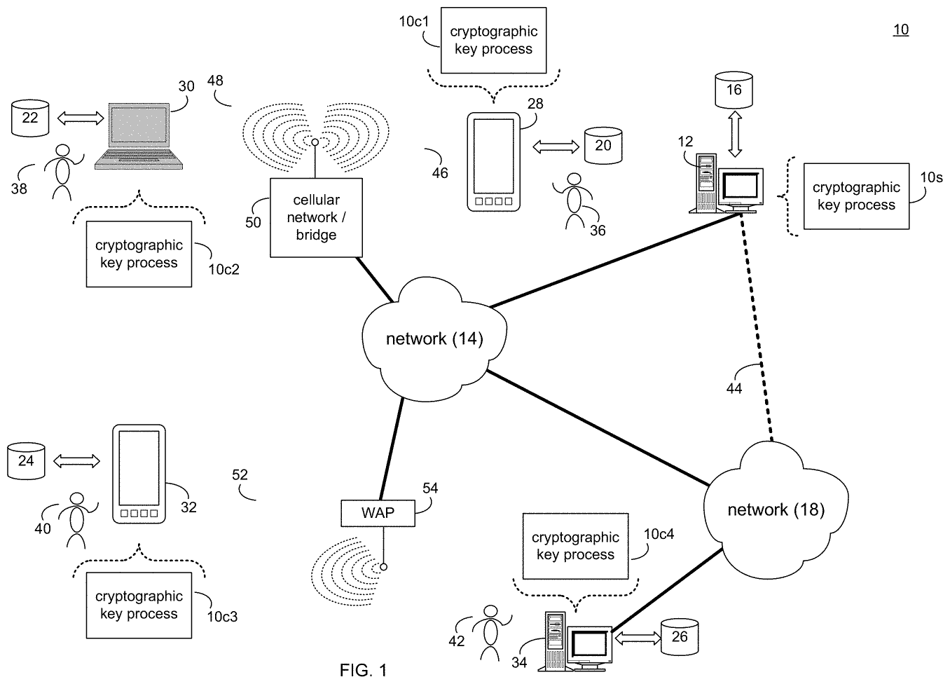

Referring to FIG. 1, there is shown cryptographic key process 10. Cryptographic key process 10 may be implemented as a server-side process, a client-side process, or a hybrid server-side/client-side process. For example, cryptographic key process 10 may be implemented as a purely server-side process via cryptographic key process 10s. Alternatively, cryptographic key process 10 may be implemented as a purely client-side process via one or more of cryptographic key process 10c1, cryptographic key process 10c2, cryptographic key process 10c3, and cryptographic key process 10c4. Alternatively still, cryptographic key process 10 may be implemented as a hybrid server-side/client-side process via cryptographic key process 10s in combination with one or more of cryptographic key process 10c1, cryptographic key process 10c2, cryptographic key process 10c3, and cryptographic key process 10c4. Accordingly, cryptographic key process 10 as used in this disclosure may include any combination of cryptographic key process 10s, cryptographic key process 10c1, cryptographic key process 10c2, cryptographic key process, and cryptographic key process 10c4.

Cryptographic key process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a cloud-based computing network.

The instruction sets and subroutines of cryptographic key process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of cryptographic key processes 10c1, 10c2, 10c3, 10c4 may include but are not limited to a client application, a web browser, a game console user interface, or a specialized application (e.g., an application running on e.g., the Android″ platform or the iOS™ platform). The instruction sets and subroutines of cryptographic key processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage device 16 may include but are not limited to: a hard disk drive; a RAID device; a random access memory (RAM); a read-only memory (ROM); and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access cryptographic key process 10 directly through network 14 or through secondary network 18. Further, cryptographic key process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Cryptographic Key Process

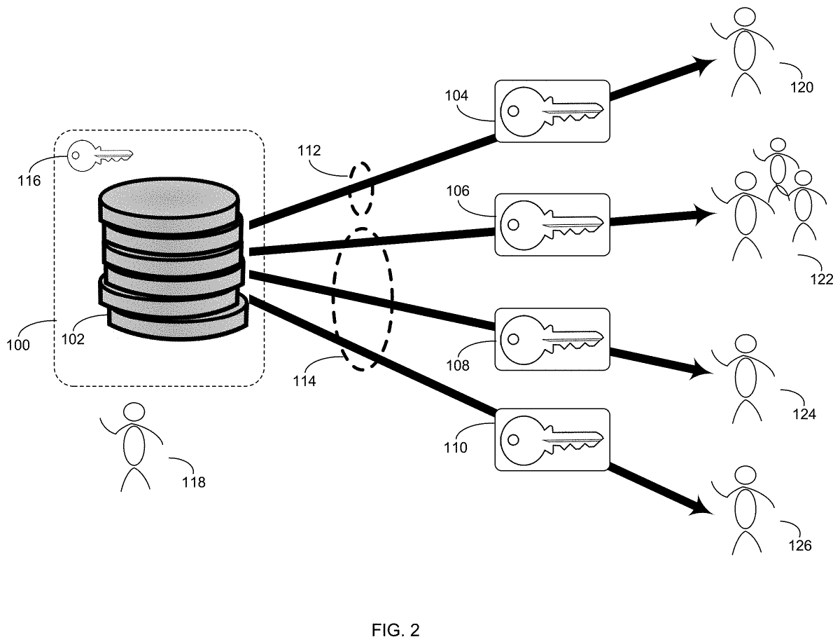

Referring also to FIG. 2 and as discussed above, modern cryptocurrency transactions may be sent from user to user using a cryptocurrency wallet (e.g., cryptocurrency wallet 100), wherein a cryptocurrency wallet is a secure way to store, send and receive cryptocurrency (e.g., tokens 102). An example of tokens 102 may include but is not limited to utility tokens.

As is known in the art, a cryptocurrency wallet (e.g., cryptocurrency wallet 100) is a device, a physical medium, a program and/or a service that may store public and/or private keys (e.g., cryptographic keys 104, 106, 108, 110) concerning a cryptocurrency and may be used to track ownership, receive and/or spend such a cryptocurrency. The cryptocurrency (e.g., tokens 102) may not actually be stored in the cryptocurrency wallet (e.g., cryptocurrency wallet 100) itself and may be stored at an entity configured to maintain such cryptocurrency. In the case of bitcoin and cryptocurrencies derived therefrom, the cryptocurrency (e.g., tokens 102) may be decentrally stored and maintained in a publicly available ledger (e.g., a blockchain ledger, not shown).

As is known in the art, a blockchain ledger may be a continuously growing list of records (e.g., called blocks) that are linked and secured using cryptography. For example, each block within a blockchain may contain a hash pointer as a link to a previous block. Accordingly, blockchains may be inherently resistant to modification of the data, as each block in the chain is linked (via a hash function) to the previous block in the chain. Accordingly, a block may include transaction data, a hash function that identifies the previous block in the blockchain ledger, and a time/date stamp. Functionally, a blockchain ledger may serve as an open, distributed ledger that may securely record transactions between two parties (e.g., the transfer of some or all of tokens 102 from a first party to a second party) efficiently and in a verifiable and permanent way.

The cryptocurrency wallet (e.g., cryptocurrency wallet 100) may be secured using a public key that identifies the address of the cryptocurrency wallet (e.g., cryptocurrency wallet 100), and a private key that is only available/known to the owner of the cryptocurrency wallet (e.g., cryptocurrency wallet 100). As discussed above, most cryptocurrency wallets currently use only one private key for all purposes (including to sign and authorize transactions). Accordingly and quite differently, cryptographic key process 10 may be configured to utilize a plurality of private keys, where each of these private keys may be configured to effectuate a different functionality.

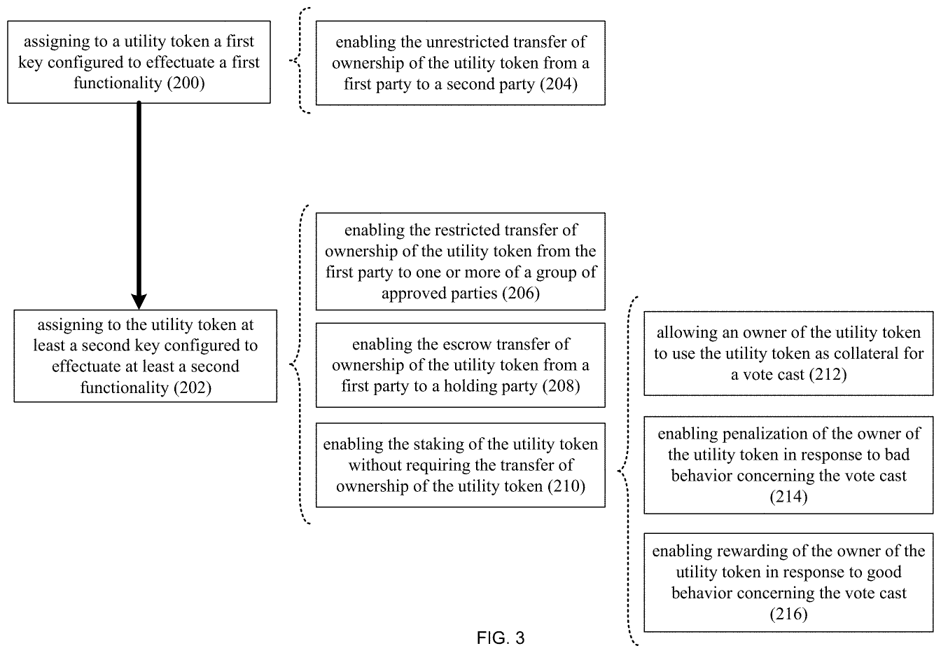

Referring also to FIG. 3, cryptographic key process 10 may assign 200 to a utility token (e.g., one or more of tokens 102) a first key (e.g., private key 104) configured to effectuate a first functionality (e.g., first functionality 112) and may assign 202 to the utility token (e.g., one or more of tokens 102) at least a second key (e.g., private keys 106, 108, 110) configured to effectuate at least a second functionality (e.g., second functionality 114). As discussed above, the cryptocurrency wallet (e.g., cryptocurrency wallet 100) may include a public key (e.g., public key 116) that identifies cryptocurrency wallet (e.g., cryptocurrency wallet 100) and enables third parties to communicate with cryptocurrency wallet (e.g., cryptocurrency wallet 100) in a secure fashion.

As is known in the art, a utility token (e.g., one or more of tokens 102) may be a token that is based upon a smart contract. An example of such a utility token may include but is not limited to a token that is based upon Ethereum ERC-20, wherein the ERC-20 has emerged as the technical standard used for all smart contracts on the Ethereum blockchain for token implementation. As of 16 Apr. 2019, more than 181,000 ERC-20-compatible tokens exist on Ethereum main network. Specifically, the ERC-20 commands vital importance, because it defines a common list of rules that all Ethereum tokens must adhere to. Consequently, this particular token empowers developers of all types to accurately predict how new tokens will function within the larger Ethereum system. This simplifies and eases developers' tasks, because they can proceed with their work, knowing that each and every new project won't need to be redone every time a new token is released, as long as the token follows the rules. ERC-20 defines six different functions for the benefit of other tokens within the Ethereum system. These are generally basic functionality issues, including the method in which tokens are transferred and how users can access data regarding a particular token. Altogether, this set of functions ensures that Ethereum tokens of different types will uniformly perform anywhere within the Ethereum system. Accordingly, nearly all of the digital cryptocurrency wallets that support the ether currency also support ERC-20-compliant tokens.

A utility token (e.g., one or more of tokens 102) may be a digital asset that not only has a value associated with it, but also has smart contract behavior built into it. So while a utility token (e.g., one or more of tokens 102) does represent value, a utility token may also implement software behavior so that you can implement functionality with the utility token.

Specifically, a utility token (e.g., one or more of tokens 102) may define rules of use. For example, a traditional token (i.e., an equity token) may function without rules, thus allowing e.g., a purchaser to purchase anything they want with the equity token. However (and being based upon a smart contract), a utility token may have rules/guidelines concerning appropriate use. For example, a utility token may: define a group of allowed transferees, may define a group of prohibited transferees, may define a list of acceptable goods/services, and/or may define a list of prohibited goods/services.

An example of the above-referenced first functionality (e.g., first functionality 112) may include but is not limited to enabling 204 the unrestricted transfer of ownership of the utility token (e.g., one or more of tokens 102) from a first party (e.g., first party 118) to a second party (e.g., second party 120). An example of such a functionality (i.e., enabling the unrestricted transfer of one or more utility tokens) may include but is not limited to the traditional transfer of the utility token (e.g., one or more of tokens 102) to effectuate the purchase of a good/service.

An example of the at least a second functionality (e.g., second functionality 114) may include but is not limited to enabling 206 the restricted transfer of ownership of the utility token (e.g., one or more of tokens 102) from the first party (e.g., first party 118) to one or more of a group of approved parties (e.g., group 122). An example of such a functionality (i.e., enabling the restricted transfer of one or more utility tokens) may include but is not limited to the gifting of the utility token (e.g., one or more of tokens 102) to a grandchild on the premise that the utility token (e.g., one or more of tokens 102) be used solely for the purpose of education. Accordingly and in such an example, the group of approved parties (e.g., group 122) may include educational institutions. Accordingly in the event that the grandchild wishes to use the utility token (e.g., one or more of tokens 102) to pay for some education courses, the transfer will be approved, while a transfer of utility token (e.g., one or more of tokens 102) to purchase a car would not be approved. Accordingly and through the use of such functionality, the utility token (e.g., one or more of tokens 102) may be transferred without fear of it being inappropriately used.

Another example of the at least a second functionality (e.g., second functionality 114) may include but is not limited to enabling 208 the escrow transfer of ownership of the utility token (e.g., one or more of tokens 102) from the first party (e.g., first party 118) to a holding party (e.g., holding party 124). As is known in the art, escrow is an arrangement where you use a “holding party” (e.g., holding party 124) that is neither the buyer nor the seller to hold something of value, wherein holding party 124 may make the transaction safer by ensuring that both the buyer and seller meet their respective obligations. Ideally, holding party 124 may be a disinterested (or neutral) party that has no interest in whether either the buyer or seller comes out ahead. Accordingly, the job of holding party 124 may be simply to ensure that the buyer and seller both stick to their end of the bargain. Accordingly and through the use of such functionality, the utility token (e.g., one or more of tokens 102) may be utilized within a transaction without fear of them being transferred prior to the other party living up to their obligations.

Another example of the at least a second functionality (e.g., second functionality 114) may include but is not limited to enabling 210 the staking of the utility token (e.g., one or more of tokens 102) without requiring the transfer of ownership of the utility token (e.g., one or more of tokens 102).

As is known in the art, staking is a way of controlling the behavior of bad actors. Often times, utility tokens and/or smart contracts are utilized to effectuate a task. As is known in the art, a smart contract is a computer protocol intended to digitally facilitate, verify, or enforce the negotiation or performance of a contract. Accordingly, smart contracts may allow the performance of credible transactions without third parties, wherein these transactions are trackable and irreversible. Proponents of smart contracts claim that many kinds of contractual clauses may be made partially or fully self-executing, self-enforcing, or both. The aim of smart contracts is to provide security that is superior to traditional contract law and to reduce other transaction costs associated with contracting. Various cryptocurrencies have implemented types of smart contracts.

For example, assume that the task to be effected by the smart contract was taking bets on the outcome of a Patriots-Rams Superbowl. So the smart contract may allow a user to pick a winner and define a wager concerning their pick. The smart contract may also define a spread depending upon how the bets are being made to make the bet even money. For example, the spread may be Patriots by 7.5 points. So if John bets on the Rams and the Patriots won but only by 7 points, John won the bet. However, if the Patriots won by 8 points, the Patriots covered the spread and John lost the bet.

At some point in time, the smart contract is going to need to know who actually won the Superbowl . . . so the smart contract may seek input concerning who won. So if John was less the honest, John might say that the Patriots won by 7 points (even though they won by 8 points), as that one point change shifts John from losing the bet to winning the bet. So in this situation, John is a bad actor and (as will be explained below) utility tokens and/or smart contracts may be utilized to discourage such bad behavior.

When enabling 210 the staking of the utility token (e.g., one or more of tokens 102) without requiring the transfer of ownership of the utility token, cryptographic key process 10 may allow 212 an owner of the utility token (e.g., one or more of tokens 102) to use the utility token (e.g., one or more of tokens 102) as collateral for a vote cast.

For example, assume that the following table represents people who bet on the above-described Superbowl via a smart contract and/or the utility token (e.g., one or more of tokens 102:

| Participant | Wallet | Bet | Pick |
|---|---|---|---|
| Charlie | 90 | 15 | Rams |
| Roman | 50 | 20 | Patriots |
| Luke | 60 | 15 | Rams |
| Nigel | 80 | 10 | Patriots |

So assume that the four people listed above made the four bets listed above. And the day after the Superbowl, the smart contract and/or the utility token (e.g., one or more of tokens 102 inquires of the four users “Who won the Superbowl and by how much?” Assuming that the Patriots won the Superbowl by 8 points and the spread was 7.5, the Patriots covered the spread and Roman and Nigel won and Charlie and Luke lost, resulting in the following updated token counts:

| Participant | Wallet | Bet | Pick | Win/Loss |
|---|---|---|---|---|
| Charlie | 75 (i.e., 90 − 15) | 15 | Rams | Lost |
| Roman | 70 (i.e., 50 + 20) | 20 | Patriots | Won |
| Luke | 45 (i.e., 60 − 15) | 15 | Rams | Lost |
| Nigel | 90 (i.e., 80 + 10) | 10 | Patriots | Won |

Further assume that when asked who won and by how much, Roman, Luke and Nigel all truthfully said that the Patriots won the Superbowl by 8 points . . . but Charlie lied and said that the Patriots won the Superbowl by 7 points (which would have resulted in the Patriots not covering the spread and Charlie winning the bet, even though the Rams ultimately lost the Superbowl). The truthfulness of the answer provided may be determined by cryptographic key process 10 via majority consensus (e.g., Roman, Luke and Nigel all said Patriots by 8 points and only Charlie said Patriots by 7 points).

As discussed above, cryptographic key process 10 may allow 212 an owner of the utility token (e.g., one or more of tokens 102) to use their utility tokens (e.g., one or more of tokens 102) as collateral for their vote cast. Accordingly, Charlie may have used his original 90 utility tokens as collateral for his vote (which was untruthful); Roman may have used his original 50 utility tokens as collateral for his vote (which was truthful); Luke may have used his original 60 utility tokens as collateral for his vote (which was truthful); and Nigel may have used his original 80 utility tokens as collateral for his vote (which was truthful).

When enabling 210 the staking of the utility token (e.g., one or more of tokens 102) without requiring the transfer of ownership of the utility token (e.g., one or more of tokens 102), cryptographic key process 10 may enable 214 penalization of the owner of the utility token (e.g., one or more of tokens 102) in response to bad behavior concerning the vote cast. Further and when enabling 210 the staking of the utility token (e.g., one or more of tokens 102) without requiring the transfer of ownership of the utility token (e.g., one or more of tokens 102), cryptographic key process 10 may enable 216 rewarding of the owner of the utility token (e.g., one or more of tokens 102) in response to good behavior concerning the vote cast.

As discussed above, Charlie was a bad actor with respect to his vote, as he lied and misrepresented the point differential as 7 points instead of 8 points. Accordingly, cryptographic key process 10 may enable 216 penalization of Charlie in response to his bad behavior concerning his vote cast. Further, cryptographic key process 10 may enable 216 rewarding of Roman, Luke and Nigel in response to their good behavior concerning their vote cast.

Assume for illustrative purposes that the penalty defined for being a bad actor is 50% of their staked tokens. Accordingly, cryptographic key process 10 may enable 214 a 45 token penalization of Charlie in response to his bad behavior concerning his vote cast. Further, cryptographic key process 10 may enable 218 the rewarding of Roman, Luke and Nigel 15 tokens each in response to their good behavior concerning their vote cast (thus redistributing the 45 token penalty paid by bad actor Charlie amongst good actors Roman, Luke and Nigel).

Accordingly and after the distribution of Charlie's 45 token penalty, the following updated token counts may be realized:

| Participant | Wallet | Bad Actor |
|---|---|---|
| Charlie | 30 (i.e., 75 − 45) | Yes |
| Roman | 85 (i.e., 70 + 15) | No |
| Luke | 60 (i.e., 45 + 15) | No |
| Nigel | 105 (i.e., 90 + 15) | No |

Thus, cryptographic key process 10 may encourage good behavior and good actors by fiscally penalizing bad behavior and bad actors.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed a computing device, comprising:
assigning to a utility token a first key configured to effectuate a first functionality; and
assigning to the utility token at least a second key configured to effectuate at least a second functionality.

2. The computer-implemented method of claim 1 wherein the utility token is based upon a smart contract.

3. The computer-implemented method of claim 1 wherein the first functionality includes enabling the unrestricted transfer of ownership of the utility token from a first party to a second party.

4. The computer-implemented method of claim 1 wherein the at least a second functionality includes:
enabling the staking of the utility token without requiring the transfer of ownership of the utility token.

5. The computer-implemented method of claim 4 wherein enabling the staking of the utility token without requiring the transfer of ownership of the utility token includes:
allowing an owner of the utility token to use the utility token as collateral for a vote cast.

6. The computer-implemented method of claim 5 wherein enabling the staking of the utility token without requiring the transfer of ownership of the utility token includes:
enabling penalization of the owner of the utility token in response to bad behavior concerning the vote cast.

7. The computer-implemented method of claim 5 wherein enabling the staking of the utility token without requiring the transfer of ownership of the utility token includes:
enabling rewarding of the owner of the utility token in response to good behavior concerning the vote cast.

8. The computer-implemented method of claim 1 wherein the at least a second functionality includes:
enabling the restricted transfer of ownership of the utility token from the first party to one or more of a group of approved parties.

9. The computer-implemented method of claim 1 wherein the at least a second functionality includes:
enabling the escrow transfer of ownership of the utility token from a first party to a holding party.

10. A computer program product residing on a computer readable medium having a plurality of instructions stored thereon which, when executed by a processor, cause the processor to perform operations comprising:
assigning to a utility token a first key configured to effectuate a first functionality; and
assigning to the utility token at least a second key configured to effectuate at least a second functionality.

11. The computer program product of claim 10 wherein the utility token is based upon a smart contract.

12. The computer program product of claim 10 wherein the first functionality includes enabling the unrestricted transfer of ownership of the utility token from a first party to a second party.

13. The computer program product of claim 10 wherein the at least a second functionality includes:
enabling the staking of the utility token without requiring the transfer of ownership of the utility token.

14. The computer program product of claim 13 wherein enabling the staking of the utility token without requiring the transfer of ownership of the utility token includes:
allowing an owner of the utility token to use the utility token as collateral for a vote cast.

15. The computer program product of claim 14 wherein enabling the staking of the utility token without requiring the transfer of ownership of the utility token includes:
enabling penalization of the owner of the utility token in response to bad behavior concerning the vote cast.

16. The computer program product of claim 14 wherein enabling the staking of the utility token without requiring the transfer of ownership of the utility token includes:
enabling rewarding of the owner of the utility token in response to good behavior concerning the vote cast.

17. The computer program product of claim 10 wherein the at least a second functionality includes:
enabling the restricted transfer of ownership of the utility token from the first party to one or more of a group of approved parties.

18. The computer program product of claim 10 wherein the at least a second functionality includes:
enabling the escrow transfer of ownership of the utility token from a first party to a holding party.

19. A computing system including a processor and memory configured to perform operations comprising:
assigning to a utility token a first key configured to effectuate a first functionality; and
assigning to the utility token at least a second key configured to effectuate at least a second functionality.

20. The computing system of claim 19 wherein the utility token is based upon a smart contract.

21. The computing system of claim 19 wherein the first functionality includes enabling the unrestricted transfer of ownership of the utility token from a first party to a second party.

22. The computing system of claim 19 wherein the at least a second functionality includes:
enabling the staking of the utility token without requiring the transfer of ownership of the utility token.

23. The computing system of claim 22 wherein enabling the staking of the utility token without requiring the transfer of ownership of the utility token includes:
allowing an owner of the utility token to use the utility token as collateral for a vote cast.

24. The computing system of claim 23 wherein enabling the staking of the utility token without requiring the transfer of ownership of the utility token includes:
enabling penalization of the owner of the utility token in response to bad behavior concerning the vote cast.

25. The computing system of claim 23 wherein enabling the staking of the utility token without requiring the transfer of ownership of the utility token includes:
enabling rewarding of the owner of the utility token in response to good behavior concerning the vote cast.

26. The computing system of claim 19 wherein the at least a second functionality includes:
enabling the restricted transfer of ownership of the utility token from the first party to one or more of a group of approved parties.

27. The computing system of claim 19 wherein the at least a second functionality includes:
enabling the escrow transfer of ownership of the utility token from a first party to a holding party.
